(19) United States
(12) Patent Application Publication
(10) Pub. No.: US 2003/0046091 A1
(43) Pub. Date: Mar. 6, 2003

(54) System and method for providing wireless services

(76) Inventors: Kenneth Arneson, Seattle, WA (US); John Clark, Seattle, WA (US); Lawrence J. Corvari, Normandy, WA (US)

Correspondence Address: MANELLI DENISON & SELTER PLLC, 2000 M Street, N.W., 7th Floor, Washington, DC, 20036-3307, US

(21) Appl. No.: 09/852,740

(22) Filed: May 11, 2001

Related U.S. Application Data
(60) Provisional application No. 60/203,885, filed on May 12, 2000.

(51) Int. Cl. G06F 17/60

(52) U.S. Cl. 705/1

(57) ABSTRACT

A system which allows wireless airtime units to be used as a medium of exchange. For example, with the novel wireless server system, wireless airtime units may be used as a form of currency by a user in exchange for other types of products or services. In addition, the novel system can be used to provide new types of incentives that reward users with airtime wireless units. Thus, wireless airtime units can be awarded to users that view electronic advertisements, visit desired web pages or purchase particular products. Users can in turn, use these wireless airtime units to obtain airtime for their wireless communications devices, or alternatively, to exchange the wireless airtime units for other goods and services.

This application claims the benefit of priority under 35 U.S.C. § 119(e) of U.S. Provisional Application No. 60/203,885, filed May 12, 2000, which is herewith incorporated in its entirety by reference.

### BACKGROUND OF THE INVENTION

1. Field of the Invention

This invention relates generally to the fields of electronic commerce and wireless telephone services. More particularly, the invention relates to a system and method for permitting electronic commerce merchants to influence user behavior by providing wireless services to consumers.

2. Background of Related Art

The Internet has evolved into a worldwide network to which millions of users, ranging from individuals to corporations, connect daily to using both permanent and dial-up connections. The computers and networks of computers making up the Internet, known as “hosts,” contain databases of information which is made available to the users. The World Wide Web (“WWW”) provides one mechanism of accessing the vast information available on the Internet. The WWW dispenses with the command-line utilities and enables the user to intuitively and easily access the information provided on the WWW.

Recently, the WWW has emerged as a viable medium for a vendor to offer its products and services and to solicit orders from users for the offered products and services. Typically, the vendor maintains a web server or web site, which is a location on the WWW. Through the web site, the vendor makes available information regarding its products and services through one or more web pages or documents contained in the web site.

The potential of reaching millions of users makes the WWW an emerging marketing and sales channel to the vendors. In order to successfully market its products and services over the WWW, the vendor must attract users to its web site. But, the increasing number of web sites, and the plethora of information made available on the web sites, makes it difficult for a vendor to attract users to its web site. Without attracting users to the web site, the information contained in the documents comprising the web site is not disseminated. Furthermore, it is beneficial to the vendor to have users repeatedly visit the web site and access the information contained in the web site.

### SUMMARY OF THE INVENTION

Even though the invention is suitable for providing a user various forms of incentives to influence the user's behavior, the invention will be further disclosed in the context of influencing the user's behavior on the World Wide Web (“WWW”) by providing wireless services, and more particularly, wireless airtime units, as a reward for certain user behavior.

An electronic commerce merchant conducts business on-line by, for example, providing its products and services over the Internet and the WWW. An electronic commerce merchant providing its wares over the WWW may be referred to as a “web merchant” or an “e-tailer.” Hereinafter, web merchant and e-tailer are used interchangeably. A web merchant offers its products and services through a web site on the WWW. Thus, it is advantageous for the web merchant to attract users to its web site and furthermore, to retain the users who visit the web site.

In one embodiment of the invention, the web merchant provides an incentive, such as, by way of example, wireless airtime units, to the users who visit the web site. The incentive is awarded to users who exhibit certain behaviors desired by the web merchant. For example, a user may be given a number of wireless airtime units every time he or she accesses a particular web page or document contained in the web site. The wireless airtime units may advantageously be used as a form of currency by the user to obtain additional products or services offered by the web merchant. Thus, the user benefits by obtaining the beneficial incentives which may be used like currency to purchase other goods and services. The web merchant benefits by increasing the number of visitors to its web site and thus increasing the potential customer base for the products and services offered through the web site. Moreover, the wireless airtime units offered through the web site provides the users a reason to return to the web site.

In another embodiment, a merchant can offer wireless airtime units in order to promote the sale of one or more of its products and services. Various identification means may be utilized to identify the purchaser so that the earned wireless airtime units are properly credited to the purchaser. In still another embodiment, the web merchant may enter into an agreement with another merchant whereby the other merchant offers purchasers of its products and services wireless airtime units. These wireless airtime units may be used as currency in purchasing products and services from the web merchant. In yet another embodiment, the web merchant may additionally offer its products and services through a conventional store. In another embodiment, a credit card company may enter into an agreement with the merchant whereby users of the credit card are given incentives which may advantageously be used to purchase products and services offered by the merchant.

Another embodiment is a method that comprises the act of purchasing offerings with wireless airtime units. Yet another embodiment is a method of providing incentives wherein the method comprises the act of offering wireless airtime units to a user in exchange for the user performing a desired action on a web site. An additional embodiment is a method that comprises the acts of offering wireless airtime units to a user in exchange for the user accessing electronic data, and crediting an account associated with the user when the user performs the desired action.

One embodiment is a method that comprises the acts of maintaining a wireless service account for a user wherein the wireless service account maintains a count of wireless airtime units, and reducing the count of wireless airtime units in the wireless service account when the user exchanges the wireless airtime units for an offering. Another embodiment is a method of obtaining wireless airtime units during a wireless call, wherein the method comprises the acts of monitoring the duration of communications between a first wireless communications device and a second communications device, determining when an account associated with the first wireless communications device needs additional airtime units, and indicating to the first wireless communication device that additional airtime units are needed.

Another embodiment is an apparatus that comprises a first account configured to store at least one wireless airtime unit, a second account configured to store at least one wireless airtime unit, and an exchange component executable in a processor, wherein the exchange component is configured to transfer at least one wireless air unit from the first account to the second account in exchange for an offering. An additional embodiment is an apparatus that comprises an incentive offer component configured to offer wireless airtime units in exchange for accessing electronic data, and a credit component configured to credit an account with wireless airtime units in response to accessing the electronic data.

Yet another embodiment is an incentive offering system that comprises a wireless service account for an entity wherein the wireless service account maintains a count of wireless airtime units, and a wireless server system that is configured to increase the count of wireless airtime units when the entity performs an action on a web site. An additional embodiment is an incentive offering system that comprises a means for offering wireless airtime units for performing a desired action, a means for electronically identifying an entity that performs the desired action, and a means for crediting an entity's wireless service account when the entity performs the desired action.

One embodiment is an incentive offering system that comprises means for maintaining a count of wireless airtime units in a first wireless service account associated with a first entity, a means for maintaining a count of wireless airtime units in a second wireless service account associated with a second entity, a means for determining when the first entity desires to obtain an offering from the second entity in exchange for a predetermined number of wireless airtime units, and a means for transferring the predetermined number of wireless airtime units from the first wireless service account to the second wireless service account.

Another embodiment is an apparatus that obtains wireless airtime units during a wireless call, wherein the apparatus comprises a wireless account database that maintains a count of wireless airtime units for a plurality of accounts, and a call processing module in communication with a wireless network and the wireless account database. The call processing module is configured to monitor the duration of communications between a first wireless communications device and a second communications device. The call processing module is further configured to determine when an account associated with the first wireless communications device needs additional airtime units. The apparatus further comprises a voice processing unit that is configured to indicate to the first wireless communication device that additional airtime units are needed.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

Features and advantages of the present invention will become apparent to those skilled in the art from the following description with reference to the drawings, in which:

FIG. 1 is a flowchart illustrating a process by which an e-tailer offers an incentive to influence user behavior in accordance with one embodiment of the present invention;

FIG. 2 is a flowchart illustrating a process by which a user obtains wireless airtime units from an e-tailer in accordance with one embodiment of the present invention;

FIG. 3 is a system block diagram illustrating an embodiment of the overall network architecture;

FIG. 4 is an example of the multiple relationships according to one embodiment of the invention;

FIG. 5 is a block diagram illustrating one embodiment of certain components of the wireless server system;

FIG. 6 is a flowchart illustrating one embodiment of a process by which an e-tailer offers wireless services through its web site;

FIG. 7 is a flowchart illustrating one embodiment of a process by which a user visits the e-tailer's web site;

FIG. 8 is a flowchart illustrating one embodiment of a process by which a user obtains additional wireless airtime units;

FIG. 9 is a flowchart illustrating one embodiment of a process by which a wireless phone call initiated from a wireless device is processed;

FIG. 10 is a flowchart illustrating one embodiment of a process by which a user purchases additional wireless airtime units during a wireless call; and

FIG. 11 is a flowchart illustrating one embodiment of a process by which a wireless user receives an incoming call to the wireless device.

### DETAILED DESCRIPTION OF ILLUSTRATIVE EMBODIMENTS

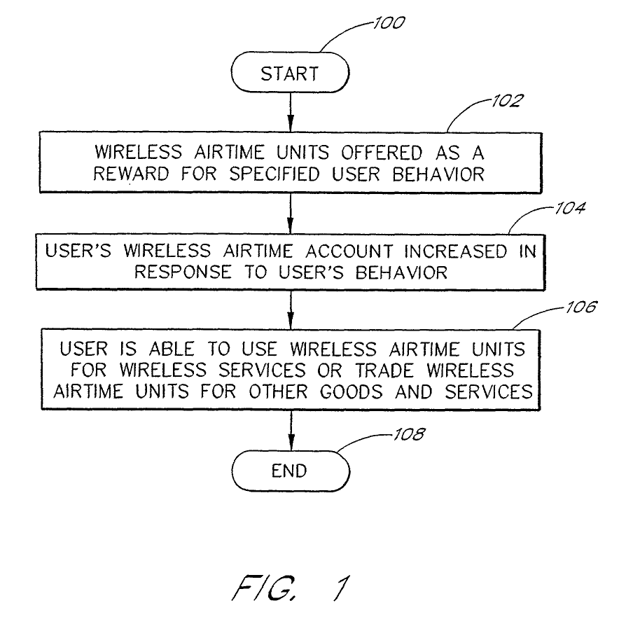

FIG. 1 generally illustrates a process by which an e-tailer offers an incentive to influence user behavior in accordance with one embodiment of the present invention. Beginning in a start state 100, an e-tailer offers wireless airtime units as a reward in state 102. One or more web pages in the e-tailer's web site may request that the user perform a specific action and offer the user wireless airtime units as an incentive to entice the user to perform the specified action.

As an example, the e-tailer may advantageously offer a number of wireless airtime units to users who purchase the e-tailer's Product A through the web site. The earned wireless airtime units are then credited to a wireless service account belonging the user exhibiting the specified behavior in state 104. If the user does not have a preexisting wireless service account, the e-tailer may provide the user an option to create the wireless service account upon the user performing the specified action.

Proceeding to state 106, the user may advantageously use the earned wireless airtime units to purchase and pay for wireless services or to obtain or purchase other goods and services offered by the e-tailer. As an example, the e-tailer may advantageously offer pre-paid wireless services, such as wireless telephone service, to users. The wireless telephone service is further discussed below.

For example, a user may purchase the wireless services offered by the e-tailer. Subsequently, the e-tailer creates a wireless service account for the user and ships a wireless communication device, such as, by way of example, a wireless phone, to the user. The user may advantageously use the earned wireless airtime units to pay for the wireless services. For example, one wireless airtime unit may be equivalent to one minute of wireless airtime usage. Thus, a user with 50 wireless airtime units is afforded 50 minutes of wireless airtime usage through his or her wireless communication device. In another embodiment, the wireless service account may advantageously be created independent of the user subscribing to the wireless services offered by the e-tailer.

Moreover, the e-tailer may advantageously offer one or more products and services to users in exchange for the wireless airtime units. By way of example, the e-tailer may offer through its web site a Product B for 300 wireless airtime units. Thus, a user with 300 or more wireless airtime units in his or her wireless service account may purchase the offered Product B. Subsequent to the user exhibiting his or her desire to purchase the Product B for the requested 300 wireless airtime units, the e-tailer advantageously obtains the necessary information to identify the user and the appropriate wireless service account in order to ship the Product B to the user and to debit the wireless service account by the 300 wireless airtime units. Having debited the wireless service account, the e-tailer proceeds to end state 108.

Furthermore, the wireless airtime units may advantageously be used to purchase products and services offered by one or more participating merchants. For example, a merchant may offer a specific product or service for a specified number of wireless airtime units. The user may then purchase the offered product or service by providing a “smart card” to the merchant. The merchant subsequently transmits the user information and the amount of wireless airtime units to deduct to the e-tailer. Here, the “smart card” advantageously functions similar to a credit card. The “smart card” is further described below.

In another embodiment, a merchant may advantageously offer users the wireless services, as described herein, through marketing and distribution channels apart from the Internet. For example, a merchant may contract with a wireless service provider. The wireless service provider is further discussed below. The merchant, in turn, advantageously offers purchasers and consumers of its products and services wireless airtime units.

For example, XYZ Company, which operates a national superstore chain, may advantageously offer consumers wireless services. The wireless services offered are purchased from a company offering wireless services, and thus, XYZ Company can benefit by offering wireless services without having to incur the costs of generating and maintaining the wireless service infrastructure. XYZ Company benefits by being able to offer wireless services, which is a complementary product, to its consumers. Furthermore, XYZ Company advantageously offers wireless airtime units to purchasers of specified products and services, and thus, XYZ Company creates and achieves consumer retention. When a consumer purchases the wireless services from XYZ Company, a wireless service account is created for the consumer. For example, the consumer may be provided an identification card which identifies the consumer and the consumer's wireless service account. Subsequently, when the consumer purchases a specified product associated with an offer of wireless airtime units, the consumer provides his or her identification card and the proper wireless service account is credited the earned wireless airtime units.

In still another embodiment, two merchants may enter into an agreement whereby a first merchant offers the wireless services and a second merchant offers wireless airtime units for use with the wireless services offered by the first merchant. Preferably, the first merchant is not itself a wireless provider, but rather, purchases the wireless services offered to the users from the wireless service provider.

Continuing the above example, ABC Company may advantageously contract with XYZ Company to offer wireless airtime units for use with the wireless services offered by XYZ Company. ABC Company may then offer purchasers a specified number of wireless airtime units for purchases of its services or products. Subsequent to a purchaser earning the offered wireless airtime units, ABC Company may advantageously identify the purchaser's wireless service account and credit the wireless service account the earned wireless airtime units.

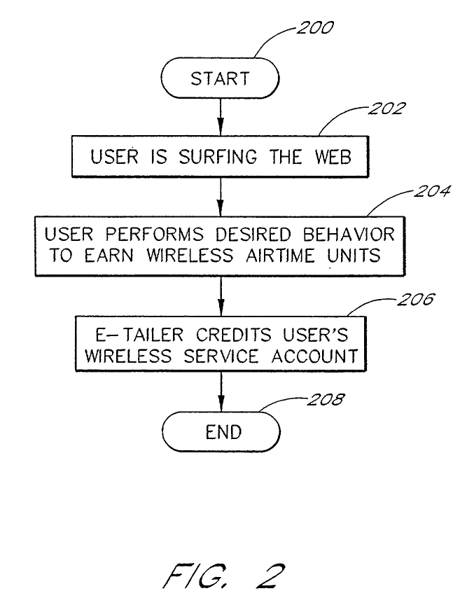

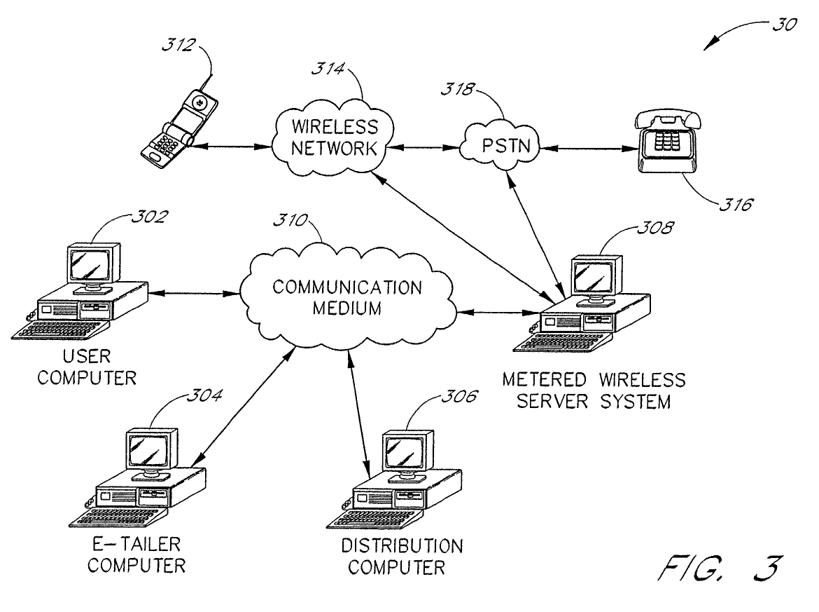

FIG. 2 generally illustrates a process by which a user obtains wireless airtime units from an e-tailer in accordance with one embodiment of the present invention. Beginning in a start state 200, a user “surfs” the WWW by executing a browser on a user computer 302 (FIG. 3) in state 202. The browser is a software program which allows a user to access different computers, including web sites and the web pages and documents contained in the web sites, accessible over the WWW and the Internet. In one preferred embodiment, the browser may be a standard browser such as the Netscape® Navigator developed by Netscape, Inc. or the Microsoft® Internet Explorer developed by Microsoft Corporation. One of ordinary skill in the art will realize that other types of access software could also be used to implement the browser. The other types of access software could be, by way of example, other types of Internet browsers, custom network browsers, communications software, cable modem software, point-to-point software, custom emulation programs, and the like.

Proceeding to state 204, the user browses one or more web pages on the WWW. While browsing the WWW, the user accesses the e-tailer's web site and views a web page which contains an incentive to entice the user to perform an action desired by the e-tailer. In particular, the user performs the action desired by the e-tailer and obtains the offered incentive. By way of example, the e-tailer may offer users visiting its web site ten wireless airtime units for viewing an advertisement for the e-tailer's web design services. An advertisement banner may advantageously be included in one or more web pages in the web site, and the user may advantageously earn the offered wireless airtime units by clicking on the advertisement banner, using a pointing device such as a mouse or the like, which causes the display of the linked advertisement regarding the e-tailer's web design services on the user's computer.

Proceeding to state 206, the e-tailer appropriately identifies the user upon the user performing the specified action to which the e-tailer offered the incentive. In particular, the web site determines the user's wireless service account and appropriately credits the wireless service account the earned number of wireless airtime units. In the above advertisement banner example, once the user views the advertisement for the e-tailer's web design services, the web site identifies the user and credits the user's wireless service account the ten wireless airtime units offered for viewing the advertisement.

In one embodiment, the web site, through one or more web pages, may advantageously request identifying information from the user subsequent to the user performing the desired activity associated with the offered incentive. The user provided information is used to identify the appropriate wireless service account. Furthermore, the provided information may be included in a “cookie” which is well known to those of ordinary skill in the art, and stored on the user's computer. The “cookie” may advantageously be used to subsequently identify the particular user and the user's wireless service account. Thus, the user advantageously provides the requested identifying information once. If the identified user does not have an associated wireless services account, the web site may advantageously offer the user the wireless services. In one embodiment, the web site advantageously creates a wireless service account for the user once the user elects to obtain the offered wireless services. Alternatively, the web site may create a wireless service account for the user irrespective of whether the user obtains the offered wireless services.

In another embodiment, the e-tailer may request the identifying information from the user when the user first visits the e-tailer's web site. The identifying information may then be placed in a “cookie” and subsequently be used to identify the user and the user's wireless service account. For example, once a user accesses a first web page in the e-tailer's web site, the web page advantageously determines if a “cookie” created by the web site, and which identifies the user, exists on the user's computer. If the requested “cookie” does not exist, the web site requests the identifying information from the user and creates the “cookie.” If the requested “cookie” exists, the web site does not request the user to submit identifying information. Subsequent to the user performing an action associated with an offered incentive, the web site uses the “cookie” to identify the user in order to determine the appropriate wireless service account.

In still another embodiment, a portal or search engine utilized by the user to access the e-tailer's web site may advantageously furnish the user information to the web site. The portals and search engines are well known to those of ordinary skill in the art as serving a navigation function, assisting on-line users by locating and accessing desired information on the Internet in a personalized manner. Examples of portals and search engines include Yahoo™, Excite™, and Lycos™. For example, the user may utilize a portal, such as Yahoo, to locate and access the e-tailer's web site. When the web site is first accessed, the portal may advantageously provide the web site the user's identifying information. The user's identification information may be maintained on the server or the portal.

In yet another embodiment, a merchant, such as, by way of example, a department store, grocery store, or credit card company, or other establishment which interacts with the user in facilitating a commercial transaction, may be the basis for providing the user's identification information to the e-tailer. By way of example, a credit card company may advantageously enter into an agreement with the e-tailer whereby the credit card company offers wireless airtime units for purchases made using their credit card. The credit card company advantageously obtains the user information from the credit card and subsequently transmits the user information and the amount of wireless airtime units earned to the e-tailer.

In an alternative embodiment, the e-tailer may provide its wireless service users a “smart card” which contains the user's identifying information in, for example, a magnetic strip or an embedded memory device attached to the smart card. One or more merchants may advantageously provide wireless airtime units for use with the wireless services offered by the e-tailer. For example, the user may advantageously earn wireless airtime units for product or service purchases made from the merchant. When the user makes a product or service purchase, the user provides the participating merchant the “smart card.” The information from the “smart card,” and the amount of wireless airtime units earned by the user, is transmitted to the e-tailer. Having credited the appropriate wireless service account, the e-tailer proceeds to end state 208.

One network architecture suitable for use with one embodiment of the invention is indicated generally by a system 30 in FIG. 3. The system 30 includes a user computer 302, an e-tailer computer 304, a distribution computer 306, and a wireless server system 308 which communicate with each other by use of a communication medium 310. The wireless server system 308 and a wireless device 312 communicate through a wireless network 314. Moreover, the wireless server system 308 and a telephone 316 communicate through a PSTN 318. Furthermore, the wireless device 312 and the telephone 316 communicate through the wireless network 314 and the PSTN 318.

A computer, including the computers 302, 304, 306, and the wireless server system 308, may be any microprocessor or processor controlled device (hereinafter referred to as processor) that permits access to the communication medium 310, including terminal devices, such as personal computers, workstations, servers, mini computers, mainframe computers, laptop computers, a network of individual computers, mobile computers, palm top computers, hand held computers, set top box for a TV, an interactive television, an interactive kiosk, a personal digital assistant, an interactive wireless communications device, or a combination thereof. The computers may further possess input devices such as a keyboard or a mouse, and output devices such as a computer screen or a speaker. Furthermore, the computers may serve as clients, servers, or a combination thereof.

These computers may be uniprocessor or multiprocessor machines. Additionally, these computers include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. In one preferred embodiment, the computers are equipped with a network communication device such as a network interface card, a modem, or other network connection device suitable for connecting to the communication medium 310. Furthermore, the computers execute an appropriate operating system such as Unix, Microsoft® Windows® 3.1, Microsoft®) Windows® 95, Microsoft® Windows® 98, Microsoft® Windows® NT, Apple® MacOS®, or IBM® OS/2®. As is conventional, the appropriate operating system includes a communications protocol implementation which handles all incoming and outgoing message traffic passed over the communication medium 310. In other embodiments, while the operating system may differ depending on the type of computer, the operating system will continue to provide the appropriate communications protocols necessary to establish communication links with the communication medium 310.

The computers may advantageously contain program logic, or other substrate configuration representing data and instructions, which cause the computer to operate in a specific and predefined manner as described herein. In one embodiment, the program logic may advantageously be implemented as one or more modules. The modules may advantageously be configured to reside on the addressable storage medium and configured to execute on one or more processors. The modules include, but are not limited to, software or hardware components which perform certain tasks. Thus, a module may include, by way of example, components, such as, software components, object-oriented software components, class components and task components, processes methods, functions, attributes, procedures, subroutines, segments of program code, drivers, firmware, microcode, circuitry, data, databases, data structures, tables, arrays, and variables.

The communication medium 310 may advantageously facilitate the transfer of electronic content. In one embodiment, the communication medium 310 includes the Internet. The Internet is a global network connecting millions of computers. The structure of the Internet, which is well known to those of ordinary skill in the art, is a global network of computer networks utilizing a simple, standard common addressing system and communications protocol called Transmission Control Protocol/Internet Protocol (TCP/IP). The connection between different networks are called “gateways,” and the gateways serve to transfer electronic data worldwide.

One part of the Internet is the World Wide Web (“WWW”). The WWW is generally used to refer to both (1) a distributed collection of interlinked, user-viewable hypertext documents (commonly referred to as “web documents” or “web pages” or “electronic pages” or “home pages”) that are accessible via the Internet, and (2) the client and server software components which provide user access to such documents using standardized Internet protocols. The web documents are encoded using Hypertext Markup Language (HTML) and the primary standard protocol for allowing applications to locate and acquire web documents is the Hypertext Transfer Protocol (HTTP). However, as used herein, the term WWW is intended to encompass future markup languages and transport protocols which may be used in place of, or in addition to, HTML and HTTP.

The WWW contains different computers which store electronic pages, such as HTML documents, capable of displaying graphical and textual information. The e-tailer computer 304 which provides content, such as advertising of products and services, on the WWW is generally referred to as a “web site.” A web site is defined by an Internet address, and the Internet address has an associated electronic page. Generally, an electronic page may advantageously be a document which organizes the presentation of text, graphical images, audio and video.

One of ordinary skill in the art will recognize that the communication medium 310 may advantageously be comprised of other types of networks without detracting from the scope of the invention. The communication medium 310 can include, by way of example, local area networks (LANs), wide area networks (WANs), public internets, private intranets, a private computer network, a secure internet, a private network, a public network, a value-added network, interactive television networks, wireless data transmission networks, two-way cable networks, interactive kiosk networks, and the like.

The wireless network 314 and the PSTN 318 are known to those of ordinary skill in the art as networks which facilitate both data and voice communications. The wireless network 314 and the PSTN 318 include one or more computers and other communication devices such as, by way of example, telephone switches and communication routers. One example of the wireless network 314 is a web of cell sites connected to a Mobile Telephone Switching Office (otherwise known as a Mobile Switching Center). One example of the PSTN 318 is the Plain Old Telephone Service.

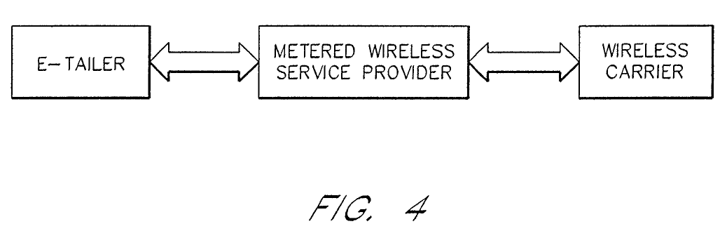

FIG. 4 generally illustrates an example of multiple relationships according to one embodiment of the invention. In one embodiment, a wireless service provider 400 contracts with a wireless carrier 402 to purchase wireless bandwidth. In this embodiment, the wireless service provider 400 continues to provide value added services such as billing, support, marketing and sales, and the like.

The wireless carrier 402 identifies the calls involving wireless communication devices 312 associated with the wireless service provider 400. The wireless carrier 402 routes the calls involving these devices to the wireless server system 308 operated by the wireless service provider 400. Once routed, the wireless server system 308 completes the routed calls. In this example, the wireless server system 308 maintains and manages user account information such as, call rating, account billing, user profile management, and the like.

The e-tailer 404 contracts for the purchase of the wireless services provided by the wireless service provider 400. In one embodiment, the e-tailer 404 and the wireless service provider 400 advantageously offer wireless services, as well as wireless communication devices 312, products, and wireless airtime units, through the e-tailer computer 304. In this example, the wireless services and products are offered under the e-tailer's brand; however, in other embodiments, the wireless services could be marketed under the brands of the wireless service provider 400, the wireless carrier 402 or other entities.

Thus, the e-tailer 404 may advantageously create an affinity program associated with the offer of the wireless services. The e-tailer 404 can use the affinity program to advantageously increase web site usage. Furthermore, the e-tailer 404 may advantageously give users wireless airtime units, for use with the wireless services, as a reward to users for returning to, making purchases on, viewing advertisements on, acquiring offerings from the e-tailer web site 304.

The wireless service provider 400 advantageously maintains and manages transactions related to the user's wireless service account. The wireless service account information is advantageously maintained by the wireless server system 308 and can be accessed through the e-tailer's web site 304. The wireless service provider 400 can charge the e-tailer 404 for the wireless airtime units the e-tailer 404 provided to users as an incentive. In some embodiments, the wireless service provider 400 can charge the user for wireless airtime units. This charge may advantageously be branded with the name of the e-tailer 404.

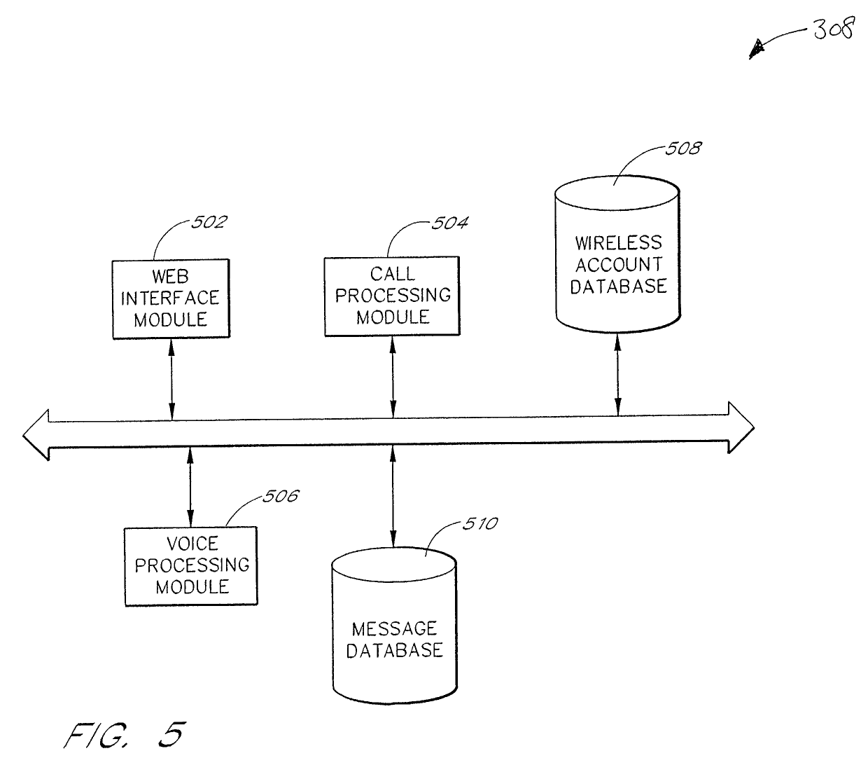

FIG. 5 is one embodiment of a block diagram illustrating certain components of the wireless server system 308. The wireless server system 308 includes an exchange module 502, call processing module 504, voice processing module 506, wireless service account database 508, and a message database 510. The depicted components may advantageously communicate with each other and other components comprising the respective computers through mechanisms such as, by way of example, interprocess communication, remote procedure call, and other various program interfaces. Furthermore, the functionality provided for in the components, modules, and databases may be combined into fewer components, modules, or databases or further separated into additional components, modules, or databases. Additionally, the components, modules, and databases may advantageously be implemented on one or more computers.

The exchange module 502 provides access to the information, such as, by way of example, a user wireless service account information, an e-tailer wireless service account information, and the like, stored on the wireless service account database 508. The e-tailer wireless service account information may advantageously be a collection of information regarding the wireless services which were distributed by the particular e-tailer 404. For example, one such information may be the number of wireless airtime units distributed to one or more users as an incentive. In one embodiment, the exchange module 502 includes one or more web pages which provide access to the user wireless service account information. The user may utilize these web pages to access his or her wireless service account in order to review and revise the information contained therein. For each wireless service user, the web pages may advantageously be branded with the associated e-tailer's name or logo. Furthermore, the one or more web pages may be accessible via a hyperlink from the e-tailer's web site 304.

The exchange module 502 may additionally include a programmable interface, such as, by way of example, the remote procedure call function in Unix, accessible over the communication medium 310 by one or more program modules executing on the e-tailer computer 304. Thus, a credit component executing on the e-tailer computer 304 may advantageously access a particular user's wireless service account through the exchange module 502 and credit the wireless airtime units available for the user. In another embodiment, the web exchange 502 may include file transfer functionality. In this case, the e-tailer computer 304 may access the information stored on the wireless server system 308 through the transfer of one or more files.

The call processing module 504 processes the calls routed to the wireless sever system 308. For each routed call, the call processing module 504 identifies the appropriate wireless service account and determines if the call should be completed. If the call should be completed, the call processing module 504 completes the call. The call processing module monitors the call and appropriately terminates the call when the available wireless airtime units are depleted or a party to the call hangs up. Furthermore, the call processing module 504 manages the accounting associated with the wireless call. For example, the call processing module 504 rates the user's wireless call and reduces the associated wireless airtime units available in the user's wireless service account by the appropriate number of units.

The voice processing module 506 communicates with the wireless device 312. For example, the voice processing module 506 may advantageously inform the wireless device 312 user of the length of the just completed wireless call and the user's available wireless airtime units. Furthermore, the voice processing module 506 may interact with the user through the wireless device 312 and facilitate the purchase of wireless airtime units through the wireless device 312. These informative messages may advantageously be one or more standard messages which are selectively modified to include user specific information. In the case the user has any voice mail messages, the voice processing module 506 may advantageously retrieve and communicate the voice mail messages to the user through the appropriate wireless device 312. The voice mail messages and the standard messages transmitted by the voice processing module 506 may advantageously be stored in the message database 510.

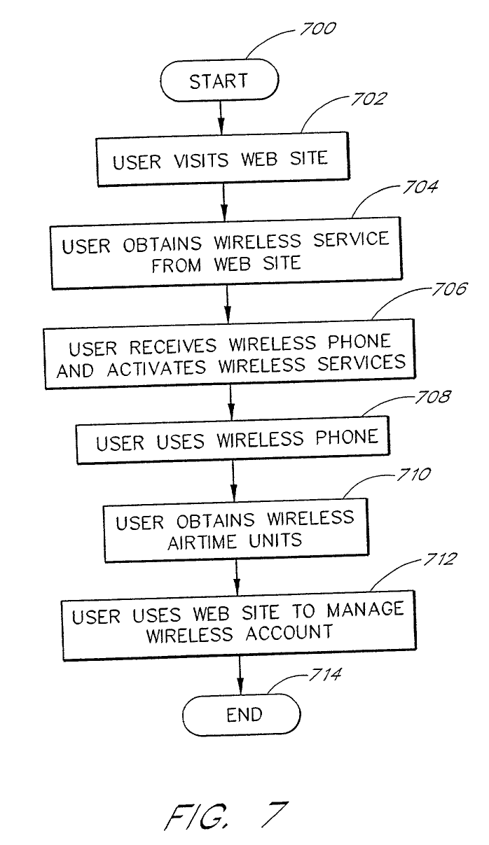

In one embodiment, a user utilizes a browser executing on the user computer 302 to communicate with the e-tailer computer 304 through the communication medium 310. The e-tailer 404 advantageously implements and maintains a web site on the e-tailer computer 304, thus enabling users to visit the e-tailer's web site through the WWW. One embodiment of a process by which a user visits the e-tailer's web site 304 is generally illustrated by the flow chart in FIG. 7. Beginning in a start state 700, the user utilizes his or her user computer 302 and visits the e-tailer's web site 304 in state 702. More particularly, the user sees an option, presented through one or more web pages, to purchase wireless services from the e-tailer 400. A wireless service offer component of the e-tailer web site 304 may comprise the web pages and program logic necessary to offer to users the wireless service. A wireless service provider 400 that is different from the e-tailer 404 may advantageously provide the wireless services which are offered by the e-tailer 404. Moreover, the e-tailer 404 may “brand” the offered wireless service with the e-tailer's name. In another embodiment, the e-tailer web site 304 may offer wireless services provided by one or more different wireless service providers 400.

In still another embodiment, the wireless service offer component may execute on one or more computers and systems other than the e-tailer web site 304. For example, the wireless service offer component may execute as part of the wireless server system 308. Here, the offer of the wireless service on the e-tailer web site 304 is linked to the wireless service offer component residing on the wireless server system 308. The wireless server system 308 is further discussed below.

Proceeding to state 704, the user elects to purchase the offered wireless services. The user accordingly provides the necessary identification information, such as, by way of example, type and model of the wireless device 312 desired, account information, and personal profile information, needed for the e-tailer 404 to request the wireless server system 308 to establish and maintain a wireless service account for the user. In one embodiment, the user submitted information is transmitted to the wireless server system 308, for example, by file transfer, e-mail, or the like. The wireless server system 308 subsequently creates a wireless service account for the user. In another embodiment, the wireless service account may be established and maintained on the e-tailer computer 304. In still another embodiment, the e-tailer 404 may create the wireless service account and accordingly notify the wireless server system 308 of the creation of the wireless service account.

Subsequent to establishing the wireless service account, a distributor may be contacted to provide and ship the wireless device 312 to the user. Either the wireless server system 308 or the e-tailer computer 304 may advantageously transmit to the distributor's distribution computer 306 the necessary information to enable the distributor to ship the requested wireless device 312 to the requesting user. The use of the distributor is optional and the distribution function may advantageously be performed by either the wireless service provider 400 or the e-tailer 404.

Proceeding to state 706, the user receives the requested wireless device 312 such as a wireless phone. The wireless device 312 advantageously arrives ready-to-use, and moreover, may be branded with the e-tailer's name or logo. In one embodiment, the user is additionally provided information on activating the wireless service account to start the wireless service. By way of example, the user may activate the wireless service by transmitting a code through the wireless device 312. In another embodiment, the user may activate the wireless service by accessing his or her wireless service account, for example, over the WWW, and providing information necessary to activate the service. The user's wireless service account is advantageously accessible through the e-tailer web site 304.

Proceeding to state 708, the user uses the wireless device 312. As an example, the user may place and receive calls through the wireless device 312. As is further discussed below, the wireless server system 308 performs the call signaling and rating associated with the user's use of the wireless device 312. Additionally, the wireless server system 308 may administer the user's wireless service account in real time to reflect the user's usage of the wireless device 312. For example, upon the user using the wireless device 312 to place a three minute call, the wireless server system 308 accordingly updates the wireless service account to reflect the user's usage of the wireless device 312 in making the three minute call. In one embodiment, the user's wireless airtime units available, which is a value maintained in the wireless service account, may advantageously be reduced by three units to reflect the three minute call. In another embodiment, a current wireless airtime usage value may be maintained in the user's wireless service account and accordingly increased by three minutes to reflect the three minute call.

Proceeding to state 710, the user advantageously obtains additional wireless airtime units. In one embodiment, the wireless services provided the user is metered or pre-paid. With this system, the user is afforded the use of the wireless service up to the wireless airtime units available as indicated in the user's wireless service account. In another embodiment, the wireless service provided the user is post paid. Here, the user uses the wireless service and pays for the wireless service periodically, for example, once a month. Moreover, the user may advantageously pay for the wireless service used with previously accumulated wireless airtime units. In another embodiment, the wireless services provided may be a combination of both pre-paid and post paid. As an example, if the user has wireless airtime units available, these units are applied to the use of wireless services (pre-paid model). If the user does not have sufficient wireless airtime units available, the wireless server system 308 accumulates the user's wireless service usage, for example in a current wireless airtime usage variable, and subsequently charges the user (post paid model).

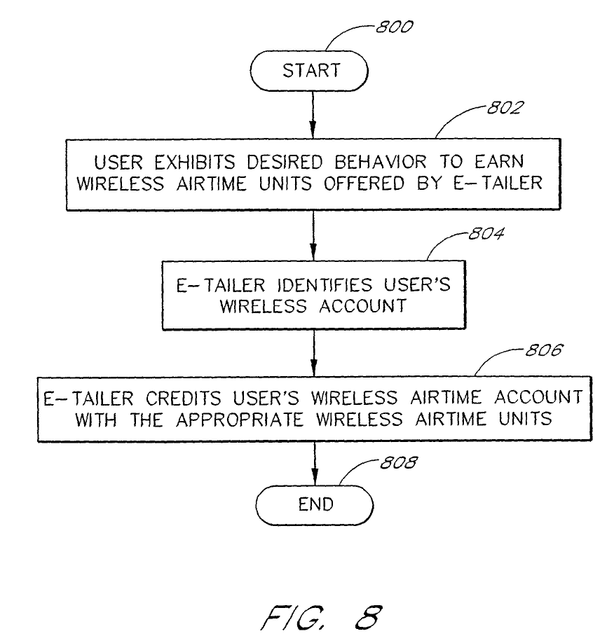

One embodiment of a process by which the user obtains additional wireless airtime units is illustrated in FIG. 8. Starting at a start state 800, the user visits the e-tailer web site 304 in state 802. Through one or more web pages residing on the e-tailer web site 304, the user is offered wireless airtime units for certain behavior desired by the e-tailer 404. In particular, the user exhibits the requested behavior to earn the wireless airtime units offered by the e-tailer 404. As an example, a web page may offer the user five wireless airtime units if the user clicks on an advertisement banner contained in the web page. The user subsequently clicks on the advertisement banner, using a pointing device such as a mouse or the like, which causes the display of the advertisement on the user computer 302. In another embodiment, the e-tailer web site 304 may provide a mechanism whereby the user may purchase wireless airtime units for a fee.

Proceeding to state 804, the e-tailer 404 identifies the user in order to credit the user the offered wireless airtime units. In particular, the user's wireless service account is identified and the wireless airtime units available is increased by the number of offered wireless airtime units in state 806. In the preceding example, the web site 304 advantageously identifies the user and the user's wireless service account and increases the wireless airtime units available by five units. Having accordingly adjusted the user's wireless service account, the web site 304 proceeds to end state 808.

Referring again to FIG. 7, the user may advantageously manage his or her wireless service account through the e-tailer web site 304 in state 712. One or more web pages preferably residing on the wireless server system 308 are accessible through the e-tailer web site 304 and the web pages provide real time account information to the user. For example, the user may advantageously access billing information including a list of all outgoing calls, incoming calls, and wireless airtime units available. Furthermore, through the web pages, the user is able to modify certain profile information such as, by way of example, credit card or debit card information in order to conveniently purchase or pay for wireless airtime units and services, speed dial information, call forwarding information, number blocking information which prohibits the user of the wireless device 312 from calling the one or more listed numbers, and user identification information.

The information maintained in the wireless service account reflects current account usage. For example, a request to block a number is effective immediately upon entering the number in the number blocking information. Furthermore, the list of outgoing calls and the wireless airtime units available value is immediately updated once the user hangs up and terminates the outgoing call. As used herein, “immediately” is understood to mean occurring without loss or interval of time other than the normal delay necessarily caused by computing components such as processors, memory devices, software and firmware execution times, network transmission delays and latencies, and the like. Having accessed and managed the wireless service account, the user proceeds to end state 714.

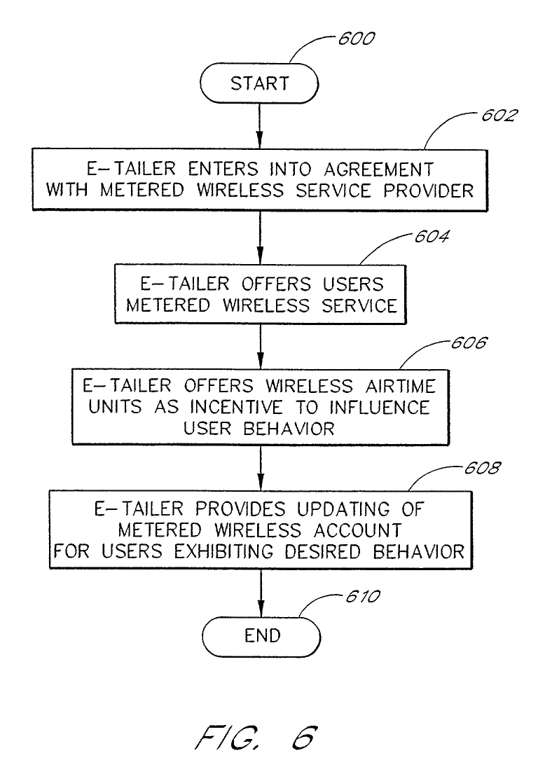

The e-tailer computer 304 contains the e-tailer's web site and the plurality of web pages included in the web site. Through the web site, the e-tailer 404 offers users wireless services and wireless airtime units. One embodiment of an offer of pre-paid or metered wireless services by an e-tailer 404 through its web site is generally illustrated by the flow chart in FIG. 6. Beginning in a start state 600, the e-tailer 404 enters into an agreement with a wireless service provider 400 in state 602. In particular, the e-tailer 404 contracts with the wireless service provider 400 to purchase wireless services and to offer the purchased wireless services, under the e-tailer's name or brand, to users over the WWW. Thus, the e-tailer 404 advantageously benefits by being able to offer wireless services under its own brand without having to incur the costs of building and maintaining a wireless service infrastructure such as the cells and the switching center.

Proceeding to state 604, the e-tailer 404 offers the wireless service through one or more web pages residing on the web site. In particular, the e-tailer 404 advantageously processes requests from users to purchase the offered wireless service through the e-tailer web site 304. One or more web pages advantageously requests information from, and processes information submitted by, users purchasing the wireless services. In one embodiment, the collected information is used to generate a metered wireless service account and the information, along with the wireless service account, may be transmitted to and maintained on the wireless server system 308.

Proceeding to state 606, the e-tailer 404 offers wireless airtime units to users as an incentive. The wireless airtime units may advantageously be offered by an incentive offer component implemented on the e-tailer computer 304. A monitor component may advantageously execute on the e-tailer computer 304 to identify users exhibiting the desired behavior. As an example, the e-tailer 404 may advantageously provide five wireless airtime units to each user who visits or browses the e-tailer's web site 304. The monitor component may then monitor the web site and identify the users who visit the web site and earn the offered wireless airtime units. The monitor component may advantageously include program logic to identify users who repeatedly visit the web site for the purpose of obtaining the offered airtime units. The monitor component may then regulate the awarding of the airtime units to the identified users. For example, a user is awarded the offered airtime units for visiting the web site one time in a predetermined time interval. The monitor component does not award the user the offered airtime units for subsequent user visits to the web site within the predetermined time interval. In another embodiment, the monitor component may advantageously monitor other user activities on the web site, such as, by way of example, purchases of specific products, in order to identify users exhibiting the behavior associated with the offered wireless airtime units.

Proceeding to state 608, a credit component advantageously identifies the identified user's wireless service account. In particular, the credit component identifies the appropriate wireless service account and updates the account information to reflect the earned wireless airtime units. In the previous example, the credit component identifies the user's wireless service account and increases the wireless airtime units available by five wireless airtime units.

In one embodiment, the credit component is executable on the e-tailer computer 304 and obtains access to the wireless service accounts and other information maintained on both the wireless server system 308 and the e-tailer computer 304 in updating user account information. In another embodiment, the credit component notifies the wireless server system 308, for example, through file transfer, e-mail, and the like, of the additional wireless airtime units earned by the user. Subsequently, the wireless server system 308 advantageously credits the earned wireless airtime units to the appropriate wireless service account. In still another embodiment, the credit component additionally identifies users purchasing additional wireless airtime units offered through one or more web pages residing on one or more web sites, including the e-tailer web site 304. Having updated the wireless service account, the e-tailer 404 proceeds to end state 610.

The wireless server system 308 interacts with the wireless device 312 and the telephone 316 through the wireless network 314 and the PSTN 318 to function as the central control for the wireless applications and services. The wireless server system 308 is maintained by the wireless service provider 400. In one embodiment, the wireless service provider 400 contracts with, and purchases wireless bandwidth and services from, one or more wireless carriers 402 such as, by way of example, Sprint, Air Touch, AT&T, and the like. The wireless service provider 400 advantageously purchases the airtime or bandwidth at a bulk rate. Furthermore, the wireless service provider 400, utilizing the wireless server system 308, integrates with the wireless carrier's wireless network 314 to facilitate the wireless services offered to users through the e-tailer 404.

As an example, the wireless server system 308 integrates with the wireless network 314 to route calls placed by the wireless service users. The wireless server system 308 advantageously performs the signaling associated with the wireless call while the purchased wireless bandwidth processes and carries the voice communication associated with the wireless call. Calls associated with the wireless service users are preferably routed by the wireless carrier 402 using Integrated Services Digital Network User Part (“ISUP”) signaling to the wireless server system 308. In one embodiment, the Signaling System 7 (“SS7”) network and the ISUP loop around trunk may advantageously be used in implementing the call routing. In another embodiment, Wireless Intelligent Networking (“WIN”) Triggers may advantageously be used in implementing the call routing. Those of ordinary skill in the art will appreciate that ISUP loop around trunk and WIN Triggers, as well as other communication standards, may be used in implementing the call routing and monitoring function necessarily performed by the wireless server system 308.

Subsequent to a call being routed to the wireless server system 308, the wireless server system 308 advantageously determines whether to complete the wireless call. For example, for both incoming and outgoing calls to and from the wireless device 312 associated with the wireless service, the wireless server system 308 advantageously determines from the appropriate wireless service account whether the necessary wireless airtime units are available to complete the call.

For a call initiated by the wireless device 312 to a particular destination number, once the call is routed to the wireless server system 308, the wireless server system 308 initiates a call to the destination number on behalf of the wireless device 314. Subsequently, the wireless server system 308 completes the call by connecting the two calls (the routed call from the wireless device 312 to the wireless server system 308 and the call made by the wireless server system 308 to the destination number).

For calls made to the wireless device 312 from a source device, the wireless network 314 routes the call to the wireless server system 308. The wireless server system 308 then initiates a call to the appropriate wireless device 312, and subsequently completes the call by connecting the two calls. Furthermore, throughout the wireless call, the wireless server system 308 may communicate with the wireless network 314 to monitor the wireless call and the associated wireless service account activity and usage. The call monitoring is further discussed below. Upon termination of the call, the wireless server system 308 accordingly updates the appropriate wireless service account to reflect the recently completed call.

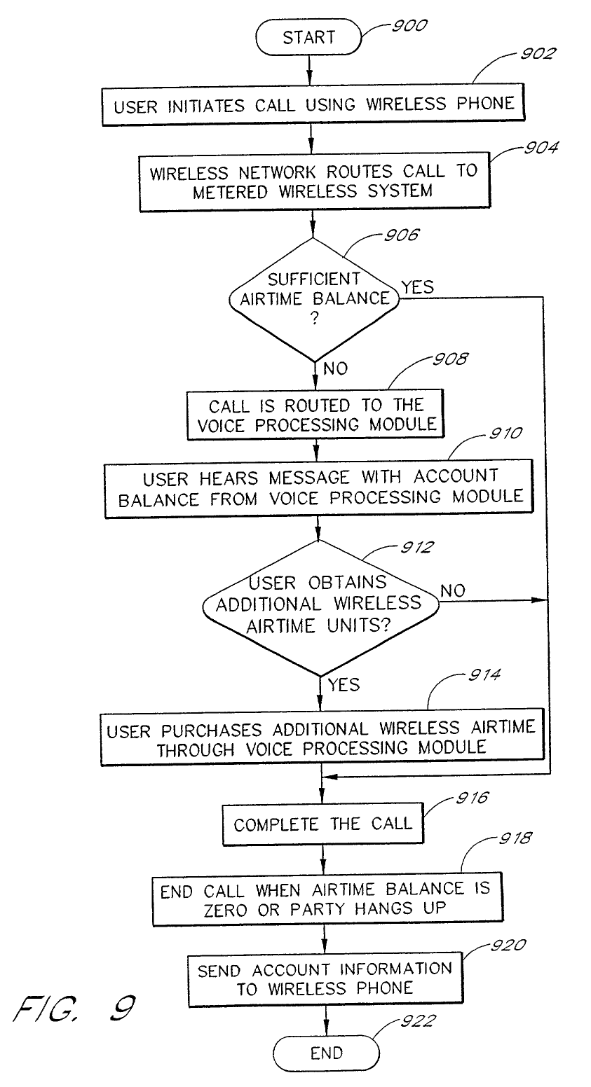

FIG. 9 illustrates one embodiment of a process by which a phone call initiated from a wireless device 312 is processed. Beginning in a start state 900, a wireless user initiates a call using the wireless device 312 in state 902. Proceeding to state 904, the wireless network 314 determines whether the wireless device 312 is associated with the wireless server system 308. For example, the phone numbers for the wireless communication devices associated with the wireless server system 308 may advantageously be maintained in a database accessible to the wireless network 314. In particular, the wireless network 314 routes the call to the wireless server system 308 for further processing.

Proceeding to state 906, the wireless server system 308 identifies the user and the appropriate wireless service account in order to determine if the user has sufficient wireless airtime units to make the call. In one embodiment, the wireless server system 308 may set a low water mark of three wireless airtime units. Thus, if the user has less than three wireless airtime units available, the wireless server system 308 advantageously determines that there are insufficient wireless airtime units available in state 906. In this case, the call is routed to the voice processing module 506 in state 908.

Proceeding to state 910, the voice processing module 506 establishes a call to the wireless device 312. The voice processing module 506 transmits a message informing the user of the wireless airtime units available. Additionally, the user is provided an option to purchase additional wireless airtime units in state 912. If the user elects to purchase additional airtime units in state 912, the purchase is made through the wireless device 312 and processed by the voice processing module 506 in state 914. The wireless airtime units purchased are immediately reflected in the user's wireless service account. Proceeding to state 916, the wireless server system 308 completes the wireless call.

Referring back to state 906, if the user had sufficient wireless airtime units available, the wireless server system 308 completes the wireless call in state 916. Proceeding to state 918, the wireless server system 308 monitors the length of the call. In one embodiment, a timer may be utilized to time the length of the call. In another embodiment, the wireless server system 308 may periodically communicate with the wireless network 314 to obtain information associated with the call. In particular, the wireless server system 308 terminates or ends the call when it detects either that the wireless airtime units available balance is zero or a party to the call hung up.

Proceeding to state 920, the wireless service account is updated to reflect the just terminated call and the voice processing module 506 transmits the updated account information to the wireless device 312. The account information may advantageously be heard by the user through the wireless device 312. In another embodiment, the account information may be transmitted to, and displayed on, the wireless device's 312 display. Having transmitted the account information, the wireless server system 308 proceeds to end state 922.

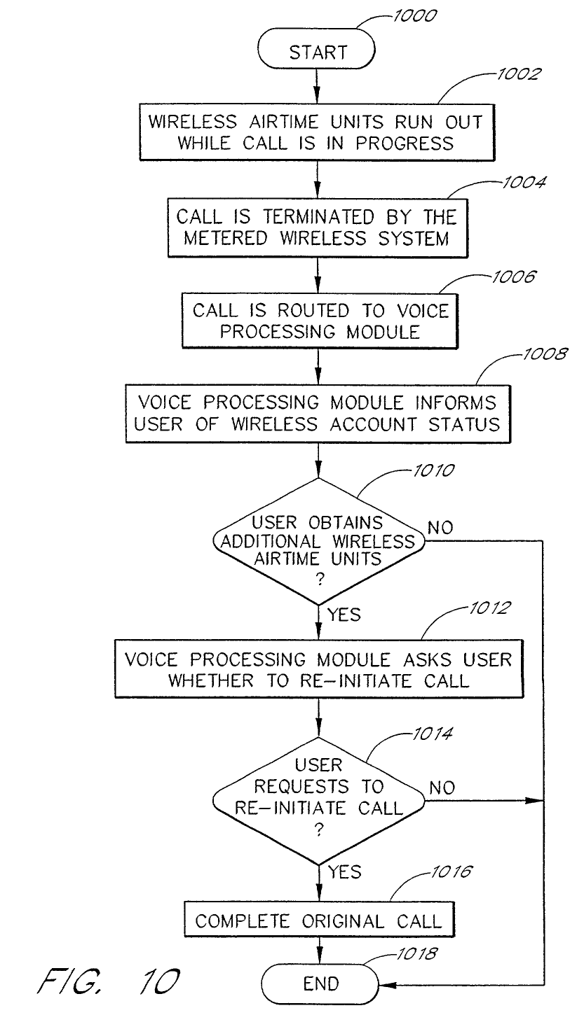

FIG. 10 illustrates one embodiment of a process by which a user purchases additional wireless airtime units during a wireless call. Beginning in a start state 1000, the user is using the wireless device 312, and during the wireless call, the wireless airtime units available is exhausted in state 1002. In one embodiment, the call processing module 504 in the wireless server system 308 may advantageously time the duration of the wireless call to determine if the wireless airtime units available have been depleted. In another embodiment, the wireless server system 308 and the wireless network 314 periodically communicate the length of the wireless call. For example, the wireless network 314 may transmit a message, such as a SS7 message, to the wireless server system 308 indicating the passage of one minute in the wireless call.

Proceeding to step 1004, the call processing module 504 terminates the wireless call subsequent to determining that the wireless airtime units available has been used up in preceding state 1002. In one embodiment, the call processing module 504 releases the segment of the wireless call from the wireless server system 308 to the non-wireless device. The call processing module 504 may retain the necessary information to re-connect to the non-wireless device. The segment of the wireless call from the wireless server system 308 to the wireless device 312 is advantageously maintained. In one embodiment, the call processing module 504 routes the terminated wireless call to the voice processing module 506 for further processing in state 1006. In particular, the voice processing module 506 communicates with the wireless user through the maintained segment.

Proceeding to state 1008, the voice processing module 506 informs the user, through the wireless device 312, that the user has exhausted the wireless airtime units available. The voice processing module 506 additionally asks if the user desires to purchase additional wireless airtime units. In one embodiment, the user may respond by voice over the wireless device 312. In another embodiment, the user may enter his or her response utilizing the keys and buttons on the wireless device 312.

Proceeding to state 1010, the voice processing module 506 determines if the user elected to purchase additional wireless airtime units. If the user elected not to purchase additional wireless airtime units, the voice processing module 506 terminates the call to the user and proceeds to end state 1018. Alternatively, if the user elected to purchase additional wireless airtime units in prior state 1008, the voice processing module 506 processes the purchase of the additional wireless airtime units. For example, the requested amount of additional wireless airtime units is received from the user and credited to the user's wireless service account. In one embodiment, the user's wireless service account contains credit card information which may advantageously be charged the cost to purchase the specified amount of wireless airtime units. In another embodiment, the user may provide the payment information utilizing the wireless device 312.

Subsequent to verifying the payment for the requested wireless airtime units, the voice processing module 506 inquires whether the user wants to re-establish the terminated wireless call to the other party in state 1012. In state 1014, the voice processing module 506 determines if the user desires to re-establish the wireless call. The user advantageously responds utilizing the wireless device 312 either by voice or by using the keys. If the user elects not to re-establish the wireless call, the voice processing module 506 terminates the call and proceeds to end state 1018.

Alternatively, if the user elects to re-establish the wireless call in preceding state 1014, the call processing module 504 reestablishes the terminated wireless call in state 1016. The call processing module 504 advantageously retained the information necessary to reestablish the call when the wireless server system 308 released the segment of the wireless call in previous state 1004. Subsequent to reestablishing the call, the wireless server system 308 proceeds to end state 1018.

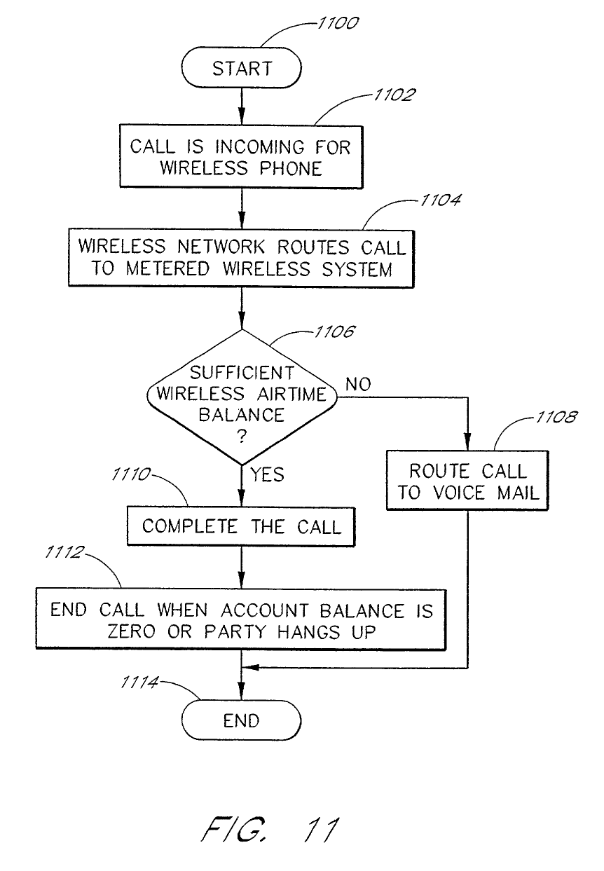

FIG. 11 illustrates one embodiment of a process by which a wireless user receives an incoming call to the wireless device 312. Beginning in a start state 1100, the wireless network 314 receives an incoming call, for example, from the telephone 316 through the PSTN 318, destined for the wireless device 312. The wireless network 314 determines that the wireless device 312 is associated with the wireless server system 308 in state 1102.

Proceeding to state 1104, the wireless network 314 routes the incoming call for the wireless device 312 to the wireless server system 308. The wireless server system 308 subsequently identifies the appropriate wireless service account associated with the particular wireless device 312. From the wireless airtime units available value maintained in the identified wireless service account, the wireless server system 308 determines if the routed call should be completed in state 1106. In one embodiment, at least one wireless airtime unit is sufficient for the call to be completed. In another embodiment, a minimum number of wireless airtime units may be required before the call is completed.

If the wireless server system 308 determines in the previous state 1106 that there was insufficient wireless airtime units available, the routed call is further routed to a voice mail processing module in state 1108. The voice mail processing module accepts a voice mail message for the wireless device 312 and proceeds to end state 1114. Those of ordinary skill in the art will realize that the voice mail processing state 1108 is optional.

If there was sufficient wireless airtime units available in previous state 1106, the wireless server system 308 completes the call to the appropriate wireless device 312 in state 1110. Furthermore, the wireless server system 308 may monitor the signaling status associated with the call. Proceeding to state 1112, the wireless server system 308 terminates the call when the wireless server system 308 detects that a party to the call hung up (ended the call) or that the wireless airtime units available for the wireless device 312 has been depleted. Having terminated the call, the wireless server system 308 proceeds to end state 1114. Those of ordinary skill in the art will realize that the wireless server system 308 may determine if the wireless device 312 user wishes to purchase additional wireless airtime units, for example, as illustrated by the process of FIG. 10, if the wireless airtime units were depleted in state 1112.

While the invention has been described with reference to the exemplary embodiments thereof, those skilled in the art will be able to make various modifications to the described embodiments of the invention without departing from the true spirit and scope of the invention.

What is claimed is:

1. A method of purchasing goods or services, comprising:
directing payment for goods or services with wireless airtime units.

2. The method of purchasing goods or services according to claim 1, wherein:
said directing payment is for payment of goods.

3. The method of purchasing goods or services according to claim 1, wherein:
said payment is for loan of said goods.

4. The method of purchasing goods or services according to claim 1, wherein:
said payment is for lease of said goods.

5. The method of purchasing goods or services according to claim 1, wherein:
said directing payment is for payment of a service.

6. The method of purchasing goods or services according to claim 1, wherein:
said directing payment transfers wireless airtime units from a buyer's account to a seller's account.

7. The method of purchasing goods or services according to claim 6, wherein:
said wireless airtime units can be used in a metered wireless communications system.

8. The method of purchasing goods or services according to claim 6, wherein:
said wireless airtime units can be used in post-paid wireless communications system.

9. A method of providing e-commerce incentives, comprising:
offering wireless airtime units to a user in response to said user performing an action on a web site.

10. The method of providing e-commerce incentives according to claim 9, wherein said action on said web site comprises:
selection of an electronic advertisement.

11. The method of providing e-commerce incentives according to claim 9, wherein said action on said web site comprises:
returning to said web site.

12. The method of providing e-commerce incentives according to claim 9, wherein said action on said web site comprises:
obtaining electronic services.

13. The method of providing e-commerce incentives according to claim 9, further comprising:
monitoring said web site to determine if said user performs said action on said web site.

14. The method of providing e-commerce incentives according to claim 13, further comprising:
creating a wireless service account for said user in response to said user performing said action on said web site.

15. The method of providing e-commerce incentives according to claim 14, further comprising:
crediting said wireless service account with said wireless airtime units.

16. The method of providing e-commerce incentives according to claim 14, further comprising:
crediting said wireless service account when said user purchases wireless airtime units.

17. The method of providing e-commerce incentives according to claim 15, further comprising:
reducing a count of wireless airtime units in said wireless service account when said user uses a wireless communications device based on said wireless service account.

18. A method of conducting e-commerce, comprising:
offering wireless airtime units to a user in exchange for said user accessing particular electronic information; and
crediting a wireless device account associated with said user with a given number of wireless airtime units when said user accesses said electronic information.

19. The method of conducting e-commerce according to claim 18, further comprising:
creating a wireless service account for said user in response to said user accessing said electronic information.

20. The method of conducting e-commerce according to claim 18, wherein:
said wireless account is a metered wireless service account.

21. A method of paying for an offering, comprising:
maintaining a count of wireless airtime units in a wireless service account associated with an entity; and
reducing said maintained count of wireless airtime units in said wireless service account when said entity exchanges wireless airtime units for a particular offering.

22. The method of paying for an offering according to claim 21, further comprising:
selling a product through a web site wherein said product can be purchased in exchange for a predefined number of said wireless airtime units in a wireless service account associated with a purchaser of said product.

23. The method of paying for an offering according to claim 21, further comprising:
accepting a predefined number of said wireless airtime units in exchange for said offering.

24. The method of paying for an offering according to claim 21, wherein:
said wireless airtime units are earned by performing an action on a web site.

25. The method of paying for an offering according to claim 21, wherein:
said wireless airtime units are earned by visiting a web site.

26. The method of paying for an offering according to claim 21, wherein:
said wireless airtime units represent metered wireless services.

27. The method of paying for an offering according to claim 21, further comprising:
crediting at least one wireless airtime unit to said wireless service account in response to behavior by said entity.

28. The method of paying for an offering according to claim 21, further comprising:
crediting one or more wireless airtime units to said wireless service account in response to said entity visiting a web site.

29. A method of exchanging wireless airtime units, comprising:
maintaining a first count of wireless airtime units in a first wireless account associated with a first entity;
maintaining a second count of wireless airtime units in a second wireless account associated with a second entity;
receiving an electronic message that said first entity desires to exchange wireless airtime units with said second entity; and
transferring at least one wireless airtime unit from said first wireless account to said second wireless account.

30. The method of exchanging wireless airtime units according to claim 29, further comprising:
maintaining said first wireless account on behalf of a website.

31. The method of exchanging wireless airtime units according to claim 29, wherein:
said transfer of wireless airtime units is in response to detection of a particular electronic commerce transaction.

32. The method of exchanging wireless airtime units according to claim 29, further comprising:
reducing said count of wireless airtime units in said first wireless account when said first entity uses a wireless communications device associated with said first wireless account.

33. The method of exchanging wireless airtime units according to claim 29, further comprising:
increasing said maintained count of wireless airtime units in said first wireless account when said first entity performs a desired action on a website.

34. A wireless device replenishment apparatus, comprising:
a first wireless account configured for a first wireless device to store at least one wireless airtime unit;
a second wireless account configured for a second wireless device to store at least one wireless airtime unit; and
an exchange component executable in a processor to transfer, in exchange for an offering associated with said second wireless device, said at least one wireless air unit from said first wireless account to said second wireless account.

35. The wireless device replenishment apparatus according to claim 34, wherein:
said offering is a good.

36. The wireless device replenishment apparatus according to claim 34, wherein:
said offering is a service.

37. The wireless device replenishment apparatus according to claim 34, wherein:
said first wireless account is associated with post-paid wireless services.

38. An incentive offering system, comprising:
a wireless service account associated with an entity, said wireless service account maintaining a count of wireless airtime units; and
a processor in communication with both an e-tailer website and said wireless service account, said processor being configured to increase said count of wireless airtime units when said entity performs a desired action on said e-tailer web site.

39. The incentive offering system according to claim 38, wherein:
said e-tailer's web site is configured to monitor activity of said entity to determine if said entity has earned offered wireless airtime units; and
said e-tailer's web site is configured to communicate with said processor to update said wireless service account with said earned wireless airtime units.

40. The incentive offering system according to claim 38, wherein:
said wireless service account is updateable with additionally purchased wireless airtime units from said e-tailer.

41. The incentive offering system according to claim 38, wherein:
said wireless service account is updateable with additionally purchased wireless airtime units from said wireless service account.
